(19) United States
(12) Patent Application Publication
(10) Pub. No.: US 2014/0107999 A1
(43) Pub. Date: Apr. 17, 2014

(54) MULTI-LEVEL ABSTRACT POWER MODELING METHOD

(71) Applicant: Silicon Integration Initiative, Inc., Austin, TX (US)

(72) Inventor: Gerald L. Frenkil, Concord, MA (US)

(21) Appl. No.: 13/937,738

(22) Filed: Jul. 9, 2013

Related U.S. Application Data
(60) Provisional application No. 61/713,165, filed on Oct. 12, 2012.

(51) Int. Cl. G06F 17/50

(52) U.S. Cl. CPC G06F 17/5009
USPC 703/17

(57) ABSTRACT

Methods, apparatuses, and computer readable media for utilizing a single model of event-based energies at multiple hierarchical levels of a design. The event-based energy model contains multiple interfaces that access or reference lower level power data, such as pin-based power data. The power of a transaction level definition of a design is estimated using the event-based energy model. The transaction-level definition of the design uses indirect references to access the event-based energy model. Other abstraction levels of the design may have their power estimated using the same low-level event-based energy model. Overall, a consistent power estimation of a design is performed using the same event-based energy model at different levels of abstraction of the design flow.

### CROSS REFERENCE TO RELATED APPLICATIONS

This application claims the benefit of priority to U.S. Provisional Patent Application No. 61/713,165, entitled “Multi-Level Abstract Power Modeling Method,” filed Oct. 12, 2012, the entirety of which is incorporated herein by reference.

### BACKGROUND

1. Field of the Invention

The present invention relates generally to electronic design, and in particular to methods and mechanisms for efficient modeling at multiple levels of the design.

2. Description of the Related Art

The design of an integrated circuit (IC) often begins with a definition of the IC at a high level of abstraction. The definition may then be refined in multiple stages going from higher levels of abstraction to more detailed lower levels. A designer uses many criteria to evaluate the performance of the design through the many stages of the design process. For example, the design may be evaluated based in part on its power consumption which may be modeled in a variety of ways.

The typical power modeling efforts in use today rely on a pin-based approach at lower levels of abstraction. To model an event in terms of its power consumption, a cell being modeled is described in terms of a pin transition. One example of an existing power modeling scheme, such as the Liberty modeling technology from Synopsys®, is defined at the cell-level or gate-level. For this modeling, power is defined in terms of pin transitions on low-level objects, such as inverters, gates, and flip-flops. For very simple logical objects, like inverters and NAND gates, this pin-based approach may be adequate. However, for more complex objects, the pin-based approach suffers from many limitations.

In addition to the above, current approaches for power modeling involve the use of different power models for different levels of abstractions of a given design or logical function. For example, one power model is used for a transaction level representation of a design and another power model is used for a gate level representation of the design. Having different power models for different levels of abstraction requires multiple power models to be created, which may in turn result in a lack of consistency between power estimates and measurements at different levels of the design. Therefore, improved methods and mechanisms for modeling power across multiple levels of design abstraction are desired.

### SUMMARY

Systems, apparatuses, methods, and computer readable media for using a single model for multiple representations of a design are disclosed. In one embodiment, consistent power modeling may be utilized across multiple design abstractions. A single event-based model may be used in any simulation, from very abstract to very detailed. This single power model may be used with multiple simulation abstractions, for example at a transaction level, register-transfer level (RTL), and bit-level. This single power model may represent a given design at multiple abstractions, allowing for more efficient and more consistent modeling throughout a design project from start to finish.

The single power model may include a base level of power data. The base level of power data may be generated by any of a variety of methods, such as characterization by measurement, simulation, estimation, and/or calculation. In one embodiment, there may be multiple interface definitions, including a separate definition for each level of abstraction. These definitions may include symbolic references to the base level of power data.

These and other features and advantages will become apparent to those of ordinary skill in the art in view of the following detailed descriptions of the approaches presented herein.

### BRIEF DESCRIPTION OF THE DRAWINGS

The above and further advantages of the methods and mechanisms may be better understood by referring to the following description in conjunction with the accompanying drawings, in which:

FIG. 1 illustrates a block diagram illustrating one embodiment of multi-level atomic power model used at multiple design levels.

FIG. 2 illustrates a block diagram of another embodiment of a multi-abstraction level power modeling scheme.

FIG. 3 is a block diagram illustrating one embodiment of a multi-ported atomic power model structure.

FIG. 4 is a block diagram illustrating another embodiment of a multi-abstraction level power modeling scheme.

FIG. 5 illustrates one embodiment of a peripheral component interface (PCI) read transaction timing diagram.

FIG. 6 illustrates one embodiment of a portion of a cell definition.

FIG. 7 illustrates another embodiment of a portion of event energy interface.

FIG. 8 illustrates one embodiment of a portion of a transaction definition.

FIG. 9 illustrates one embodiment of a portion of an architecture definition.

FIG. 10 illustrates a block diagram of one embodiment of a cell definition for multi-level power modeling.

FIG. 11 is a block diagram of one embodiment of a system.

FIG. 12 is a generalized flow diagram illustrating one embodiment of a method for estimating power at multiple abstraction levels based on a single family of event-based models.

FIG. 13 is a block diagram of one embodiment of a computer readable medium.

FIG. 14 illustrates a block diagram of another embodiment of a multi-abstraction level power modeling scheme.

### DETAILED DESCRIPTION OF EMBODIMENTS

In the following description, numerous specific details are set forth to provide a thorough understanding of the methods and mechanisms presented herein. However, one having ordinary skill in the art should recognize that the various embodiments may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

This specification includes references to “one embodiment”. The appearance of the phrase “in one embodiment” in different contexts does not necessarily refer to the same embodiment. Particular features, structures, or characteristics may be combined in any suitable manner consistent with this disclosure. Furthermore, as used throughout this application, the word “may” is used in a permissive sense (i.e., meaning having the potential to), rather than the mandatory sense (i.e., meaning must). Similarly, the words “include”, “including”, and “includes” mean including, but not limited to.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A system comprising a power estimation unit . . . .” Such a claim does not foreclose the system from including additional components (e.g., a display unit, a network interface).

“Configured To.” Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, in a modeling system having three interfaces to event-based models, the terms “first” and “second” interfaces can be used to refer to any two of the three interfaces.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

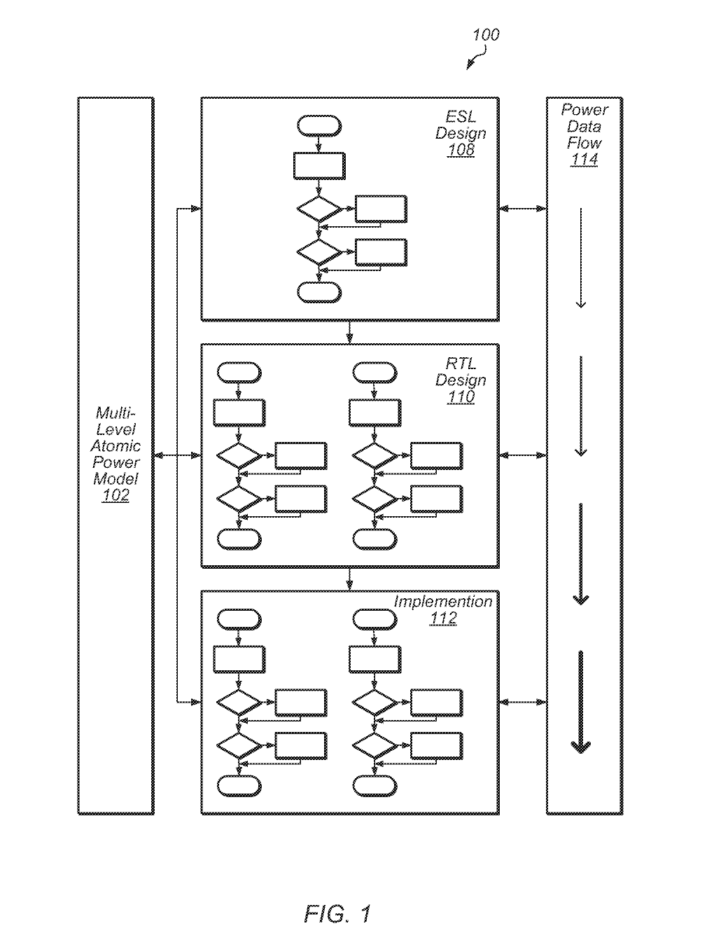

Referring now to FIG. 1, a block diagram illustrating one embodiment of a power modeling system. In the illustrated embodiment, multi-level atomic power model 102 may include a library of power models at a base level for a plurality of elements. These models 102 may be used by the multiple design abstraction levels. In one embodiment, the base level power data may be defined in terms of event energies. Energy consuming events may be defined in terms of mode, or state, transitions. The events may include symbolic names for mode transitions. For event-based modeling, events may be defined without regard to particular pin transitions. Alternatively, in some cases, there may be indirect linking from the events to pin transitions. In one embodiment, multiple interface definitions may be included and used with the event energies, with a separate interface definition for each design level. In some embodiments, each of the interface definitions may be defined in terms of the base interface and/or an interface to another abstraction level.

The models 102 may be used for determining the power or energy consumption of the design at multiple abstraction levels. The models 102 may also include leakage power data, or may reference lower level leakage power data. In further embodiments, the models 102 may include a definition of timing data and may be used for determining the timing performance of the design at multiple abstraction levels. The timing models may be used at multiple abstraction levels in a similar fashion to the multi-level atomic power model. In other embodiments, the models may include a definition of other performance characteristics and may be used for estimating and/or calculating other metrics which measure the performance data of the design at multiple abstraction levels. It is further noted that elsewhere in this disclosure, although a given model may be described as a power model, it is to be understood that the term power model may refer to a timing model, noise model, or other performance-related metric model.

The event energies defined in models 102 may be referenced by each level of the design. In one embodiment, the highest level of the design process may be the transaction level, or electronic system level (ESL) design 108. The middle level of the design process may be the register-transfer level (RTL) design 110. The bottom level of the design process may be the gate-level, or implementation 112, of the design. Each of these levels may have symbolic, or indirect, references to the multi-level atomic power model 102. In some embodiments, the separate levels of design flow 100 may be stimulated with a plurality of signals for simulation and/or evaluation purposes.

It is noted that the design flow shown in FIG. 1 with three separate levels is only one example of a design flow. In other design flows, there may be more than or fewer than three separate levels. In these design flows, the same type of modeling may be performed which utilizes a single event-based set of power models to generate the power estimation/consumption models at different abstraction levels within the design flow hierarchy. It is further noted that in other embodiments, the design flow may vary. For example, a bottom-up approach may be used in one embodiment, where the design is defined at lower levels first and then the middle and higher levels of abstraction are defined after the lower levels. In one embodiment, the bottom-up approach may involve extending a pin transition based power model by using symbolic names to reference pin transitions. Then, these symbolic names may be used at higher levels of the design. In another embodiment, a meet in the middle approach may be used, where a high level of abstraction and low level of abstraction may be defined for the design in parallel, and then the middle level of abstraction may be defined last.

The bubble elements shown in blocks 108, 110, and 112 are representative of any type of design task which may be undertaken or executed at various levels of the design flow 100. For the set of design tasks in blocks 108, 110, and 112, only a subset of the library of multi-level atomic power models 102 may be referenced to generate power models at the respective levels of the design. The designs represented by the various levels shown in design flow 100 may be incorporated within any type of integrated circuit (IC) or computer chip. The IC may be utilized within any type of electronic device, such as a phone, tablet, computer, or other device.

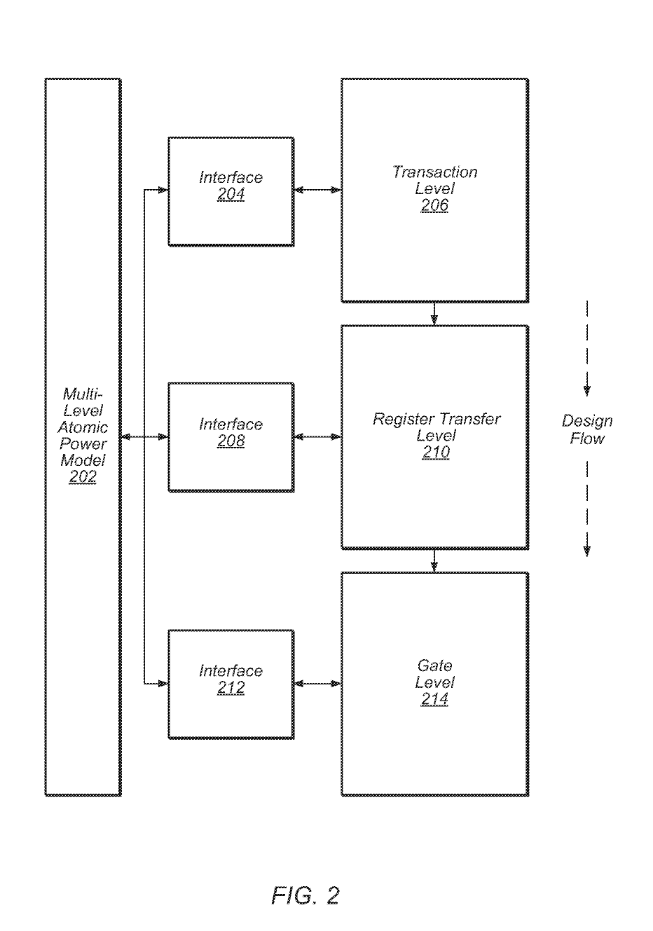

Turning now to FIG. 2, another embodiment of a block diagram representing a multi-abstraction level power modeling scheme is shown. Multi-level atomic power model 202 may be based on the power consumed by various events and/or by the change of state for various cells, modules, or components within the design. Model 202 may be accessed via interface 212 at a lowest level of the design, which is represented in FIG. 2 by gate level design block 214. Interface 212 may provide an interface from the low-level elements of gate level design 214 to the event-based models of atomic power models 202.

The register-transfer level (RTL) design 210 may utilize interface 208 to interface to multi-level atomic power model 202. Interface 208 may provide references from the RTL representation of the design to the various event-based description of atomic power model 202. In a similar fashion, the transaction level design 206 may utilize interface 204 to interface to multi-level atomic power model 202. Interface 204 may provide references from the transaction level modeling representations to the various event-based descriptions of multi-level atomic power model 202. Each of interfaces 212, 208, and 204 may provide indirect, or symbolic, references to the underlying multi-level atomic power model 202.

Generally speaking, event-based modeling may define power in terms other than just pin transitions. Power-consuming events may be defined in terms of any kind of transitions. For example, power-consuming events may be defined in terms of a change of state, and the change of state may refer to any type of entity. This event-based modeling may be made available to different types of software tools for calculating power consumption.

In various embodiments, the event-based modeling may be applied to abstract simulation. For example, in one embodiment, event-based modeling may be used to simulate an instruction stream being processed by a microprocessor. The amount of power consumed when going from the previous instruction to the next instruction may be modeled using event-based modeling. In another embodiment, the change of state of a computing system or of an operating system may be modeled. For example, the change of state from running an excel spreadsheet to running a word document may be modeled. These events may be simulated at a very abstract level using event-based modeling.

Therefore, to extend event-based modeling to higher levels of abstraction, one or more layers may be added on top of the low-level events. Each layer may define an interface to a different abstraction level. A designer may target a specific technology or fabrication process for a particular design, and low-level events (e.g., pin-based transition data) may be based on this process. If at a later point, the designer targets a different type of technology, the designer may swap out the old pin-based data for the new pin-based data for the new target technology. The designer can then customize each power analysis by using models for the particular technology or fabrication process being targeted and, with this invention, the higher level power consuming events need not be swapped out since they reference the pin-level technology data by indirection.

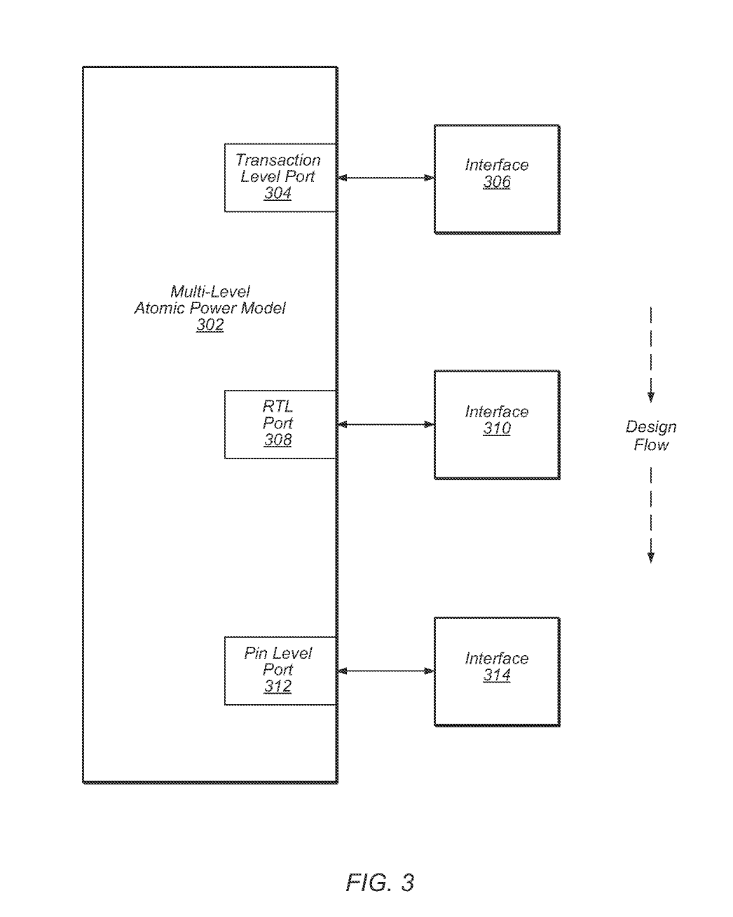

Referring now to FIG. 3, a block diagram of one embodiment of a multi-ported atomic power model structure is shown. In various embodiments, multi-level atomic power model 302 may include multiple ports for accessing models 302 at different levels. In the embodiment shown in FIG. 3, there are three separate ports for accessing the underlying power data of models 302. These ports include transaction level port 304, RTL port 308, and pin level port 312. In various embodiments, interface 306 may be utilized by a transaction-level model of a design, interface 310 may be utilized by RTL model of a design, and interface 314 may be utilized by a gate level model of a design.

Models may be constructed for a variety of entities. For example, in one embodiment, a model may be constructed for a digital signal processor (DSP). The power models may be setup to support multiple levels. For example, the models may be accessed through the transaction level, through the pin level, or through some other level. In a software application that is using these models, the models may determine which port to respond to. For example, the model may determine whether to return power data thru the pin level port 312, through the register transfer level port 308, or through the transaction level port 304. In one embodiment, a conditional expression may be used to determine which port to return power data. For example, in one scenario, the conditional may be based on the value of a command line argument. This may be implemented such that if the argument is a first value, then the pin level port 312 may be used, if the argument is a second value, then the register transfer level port 308 may be used, or if the argument is a third value, then the transaction level port 304 may be used.

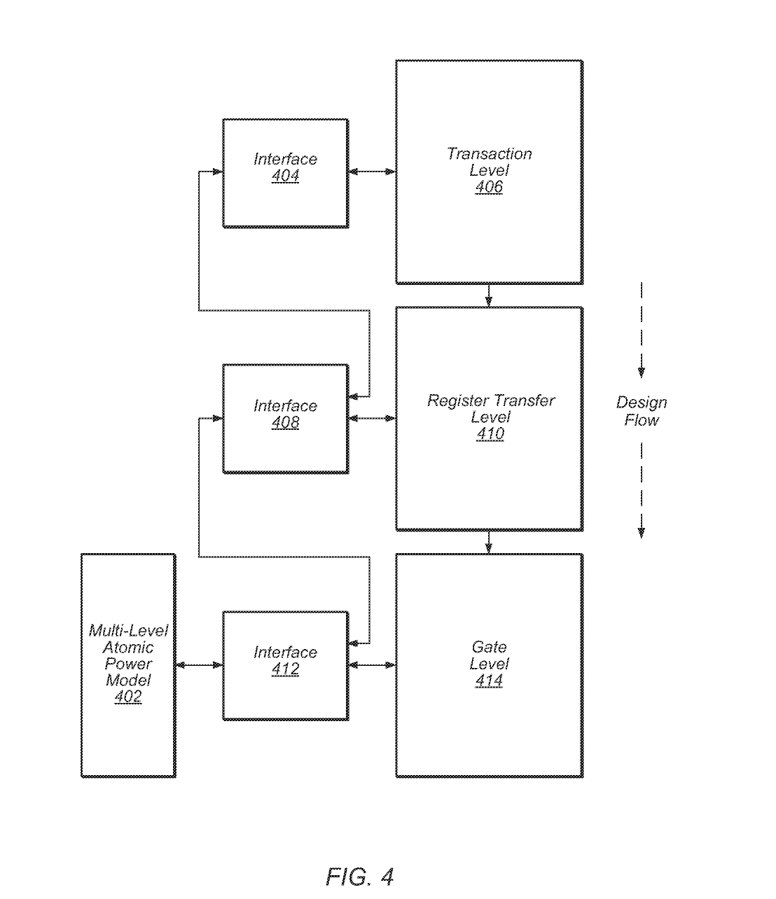

Turning now to FIG. 4, another embodiment of a block diagram representing a multi-abstraction level power modeling scheme is shown. Multi-level atomic power model 402 may be utilized at multiple abstraction levels within the design flow, similar to the examples shown in FIGS. 1 and 2. The design flow may include transaction level 406 at a highest level, register transfer level 410 at a middle level, and gate level 414 at a lowest level.

As shown in FIG. 4, the interfaces to the models 402 may be cascaded together in a series to create the power consumption model at the higher abstraction levels. For example, to generate a power consumption model at the transaction level 406 of the design, interface 404 may reference interface 408, which in turn may reference interface 412. Then, interface 412 may provide a final indirect reference to model 402. In this way, the work utilized in generating interface 412 may be reused by upper levels of the design hierarchy. In some embodiments, the chaining of interfaces 404 may be structured similarly to function calls within a programming language. For example, a call in interface 404 may refer to a function in interface 408, which in turn may call a function in interface 412, which in turn may include a symbolic or indirect reference to one of the event-based models of models 402. In some embodiments, there may be a linker that joins together the interfaces 412, 408, and 404. This linker may combine the interfaces during a compilation stage of the modeling code used to generate models at the higher abstraction levels of the design.

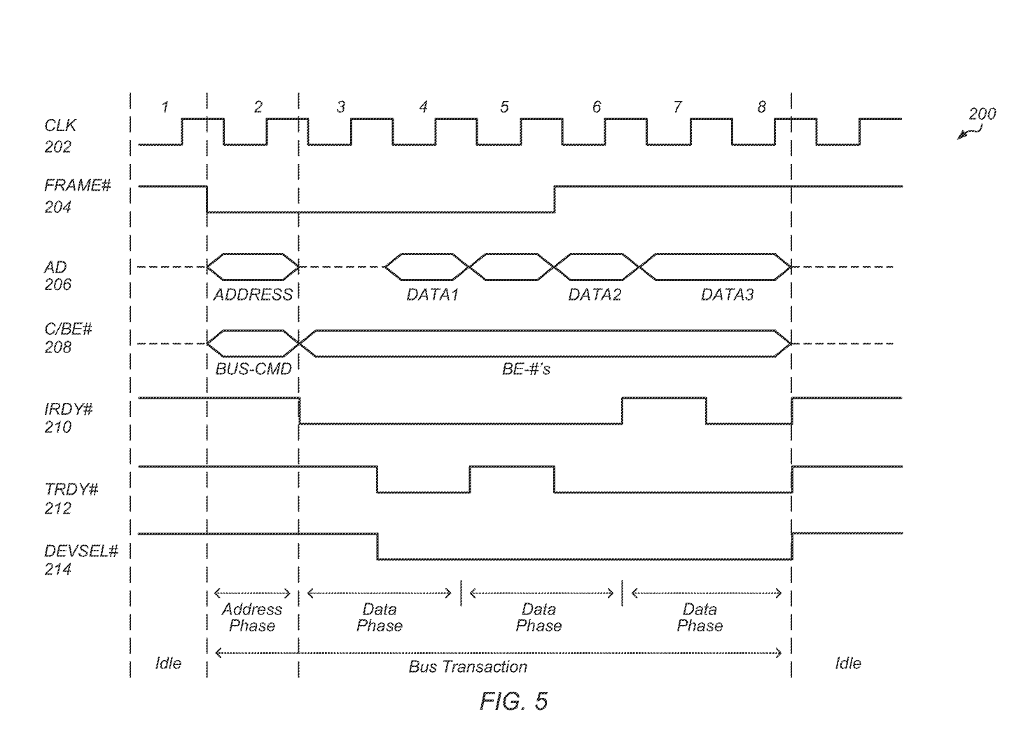

Turning now to FIG. 5, one embodiment of a peripheral component interface (PCI) read transaction timing diagram is shown. The PCI read transaction is one example of a transaction which may be defined both in terms of base power data and an interface definition which interfaces to the base power data. The timing diagram shown in FIG. 5 shows the various signals for a PCI read transaction.

The top signal CLK is shown with a clock signal and each clock period numbered, with clock periods 1 through 8 shown in FIG. 5. The next signal, FRAME#, the frame indicator signal for the PCI bus, is driven active low by the initiator of the PCI read transaction. The next signal, AD, shown in FIG. 5 represents the address and data of the PCI bus. The next signal, C/BE, designates a specific PCI command for the transaction. IRDY# is driven active low to indicate the initiator is ready. TRDY# is driven active low to indicate the target is ready. The DIESEL# may be driven active low by the target when the target detects its address on the PCI bus. As shown, the bus transaction encompasses an address phase and three data phases.

It is noted that the timing and signals shown in FIG. 5 are shown for illustrative purposes only. In other embodiments, the timing and signals may differ slightly for other implementations of PCI interface bus transactions. It is also noted that the PCI interface transaction is only one example of a transaction that may be modeled using the techniques disclosed herein. Other transactions may be modeled in a similar fashion using these same techniques.

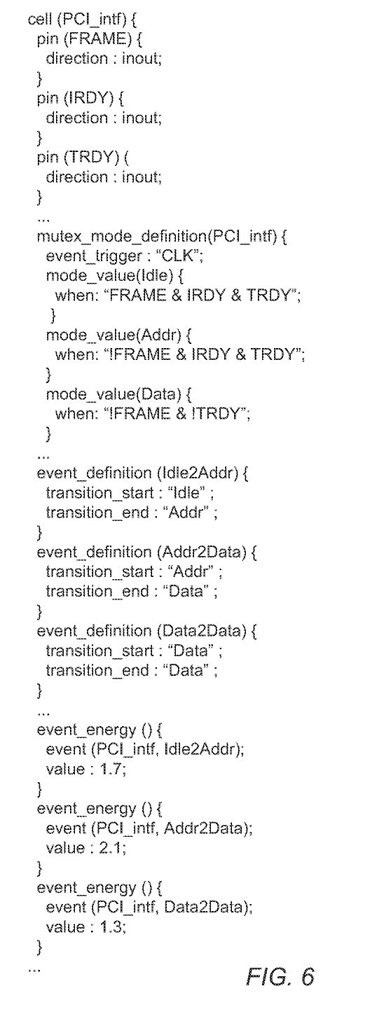

Referring now to FIG. 6, one embodiment of a portion of a cell definition is shown. In other embodiments, the term “cell” may be referred to as a “module”. The definition of the cell is one example of the definition of a cell for a PCI interface. It is noted that only a portion of the actual PCI interface is shown in FIG. 6. Many pins, modes, and events of the PCI interface are not shown in FIG. 6 to avoid cluttering the figure. Also, it is noted that the type of format and syntax shown in FIG. 6 is only one possible example of a cell definition. Other embodiments of cell definitions may use other suitable formats and syntax.

As shown in FIG. 6, the pins FRAME, IRDY, and TRDY may be defined. Each of these pin directions is defined as inout. Also, the cell definition may include a mode definition for the PCI interface. The event_trigger may be based on the clock “CLK” signal, and three modes (Idle, Addr, Data) may be defined based on the previously defined pins.

Next, events may be defined in the cell definition. As shown, three separate events (Idle2Addr, Addr2Data, Data2Data) are defined, with each event including a transition start and a transition end. Then, the event energies may be defined. Each event energy shown in FIG. 6 includes a hard-coded energy value. However, it is noted that in other embodiments, the event energy may include a reference to another underlying energy value, such as a pin based transition data. The existing low level data, which may be pin-based transition data, may be accessed by the event energy definitions. In further embodiments, some event energies may reference pin-based data while other event energies may reference hard-coded values. For example, in various embodiments, lower level event energies may be referenced if present. Otherwise, a hard coded value may be utilized. Numerous such alternatives are possible and are contemplated.

It is noted that the cell may be defined in various other ways depending on the embodiment. For example, in another embodiment, the cell may be broken up into multiple separate definitions. The separate definitions may include the top level of the cell, the modes, event definitions, and event energies. Then, a linking stage may link together the separate definitions into a single cell definition. This single cell definition may be similar to that shown in FIG. 6, or it may utilize any suitable format and syntax.

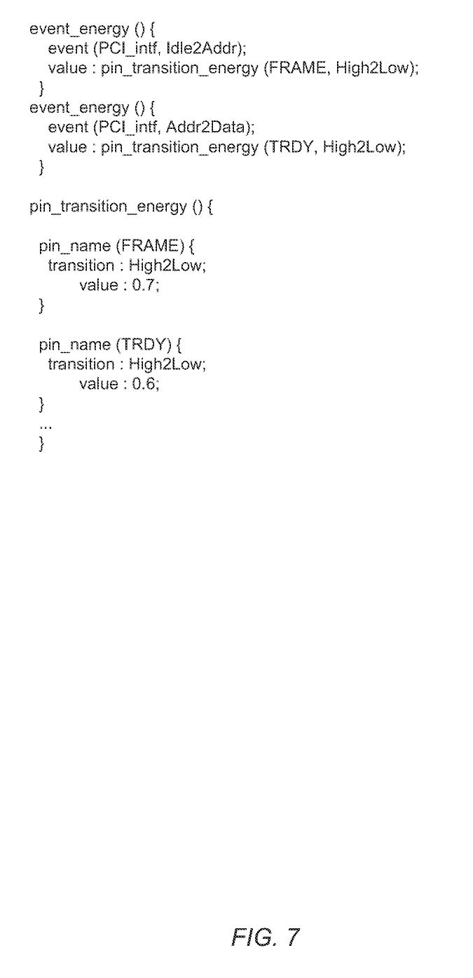

Turning now to FIG. 7, another embodiment of a portion of an event energy interface is shown. In contrast to the event energies defined in FIG. 6, the event energies shown in FIG. 7 include references to pin transition data. An extra layer of indirection is used to generate a value for the corresponding event_energy. Each event_energy call references a pin transition energy function, and then an actual value is retrieved from the pin transition energy function.

These event energies may be used in embodiments when the underlying data is defined in terms of pin transitions. Therefore, instead of having a hard-coded value for the event energy, as shown in FIG. 7, a reference to another function may be used. In this case, the reference is to a pin transition energy function, and each pin transition energy function includes a hard-coded value which may be used by event_energy function which generated the call. It is noted that the hard-coded values shown may be generated in any of a variety of ways, depending on the embodiment, including characterization by measurement, simulation, estimation, and/or calculation.

Alternatively, a conditional statement may be used in the event_energy definition. This may determine which value is used based on whether pin transition data is available or not. In one embodiment, a global variable may be set to indicate if the pin transition data is available, and the conditional statement may be based on the value of this global variable. If pin transition data is available (global variable=1), then the pin transition data may be used for any calls to the event_energy function. If pin transition data is not available (global variable=0), then a hard-coded value may be used instead. It is noted that this condition may be reversed in some embodiments, such that if hard-coded values are available, then these hard-coded values may be used, and pin transition data may be used only if the hard-coded values are not available. It is also noted that more than two possibilities of underlying data may be available, and the conditions may include other variables or other determining factors to determine which underlying data to use.

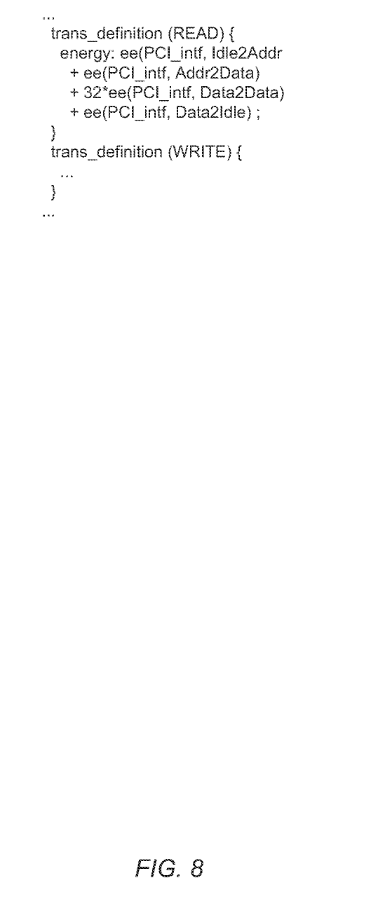

Referring now to FIG. 8, one embodiment of a transaction definition is shown. A PCI read transaction is defined in terms of the energy events which occur as part of the transaction. As shown, the PCI read transaction includes an equation, and the equation is referencing event-based data. Specifically, the equation includes four events that are referred to as part of the PCI interface definition. A PCI-read transaction may be composed of one idle-to-address phase, or mode, transition, one address-to-data phase transition, 32 data-to-data self-transitions, and one data-to-idle phase transition. It may be assumed that a fixed value of 32 data phases are included within a PCI-read transaction for this example. Also, the bus may be assumed to be in an idle state when a transaction is not active. Note that the fixed value of data phases is used for example only and that it need not be fixed, as the number may be parameterized in a more complex embodiment.

It is noted that other transactions may be defined in a similar fashion for the purpose of estimating the power or energy consumption of a transaction. For example, a PCI write transaction may be defined in a similar fashion to the PCI read transaction, in terms of the events that take place as part of the transaction.

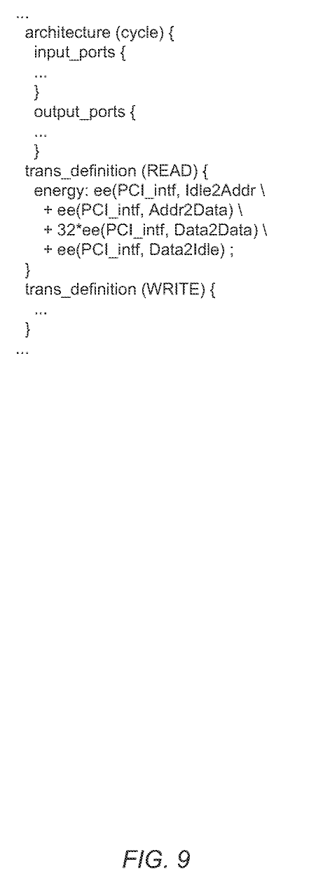

Turning now to FIG. 9, one embodiment of creating an architecture of a transaction-based model is shown. A transaction-based model may use the event-based model capabilities as a foundation. For example, in one embodiment, the transaction may be defined, in this case using “trans_definition”. Then, the energy consumed as a function of previously defined event energies (ee) may be listed within the transaction definition.

The very-high-speed integrated circuits (VHSIC) hardware description language (VHDL) architecture provides a means for specifying one of multiple model compositions (e.g., behavioral, RTL, structural). For a traditional VHDL model, there may be only a single interface, but the model may be evaluated in multiple ways. However, in the methods and mechanisms disclosed herein, the VHDL method of specifying multiple architectures for a single interface may be altered such that there are multiple interfaces to a single evaluation. In one embodiment, the single evaluation may reference the event energies at the lowest level. In another embodiment, the single evaluation may reference the pin-based data at the lowest level. In a further embodiment, multiple interfaces may be generated for multiple evaluations, and the multiple evaluations may include a power description at the event energy level, a power description at the pin level, and one or more other power descriptions.

In one embodiment, VHDL may be expanded to functionally support transaction level interfaces to a multi-level atomic power model. This would extend VHDL to be applied for high-level functional modeling applications. It is noted that other languages besides VHDL may be used to describe and define the overall power consumption estimation framework and interfaces between design levels and power consumption data. These other languages may include C, Verilog, or any other appropriate programming language. Alternatively, a new language may be created and used for the syntax and semantics of the multi-level atomic power model and the interfaces to this model.

In one embodiment, the transaction-based model may include a definition of the architecture. The architecture may be defined as using cycle, loosely timed (LT), or approximately timed (AT) based timing. If the architecture type is not specified, the basic cell definition may be used for backwards compatibility.

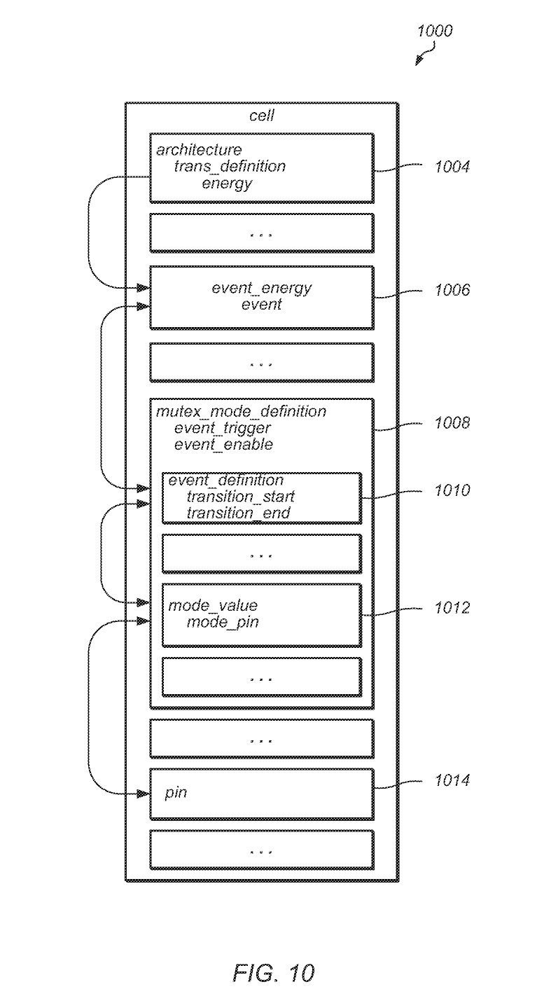

Referring now to FIG. 10, a block diagram of one embodiment of a cell definition for multi-level power modeling is shown. The cell is representative of any type of transaction, component, module, logic function, or other entity for which modeling may be performed. The example shown in FIG. 10 represents a hierarchical structure for generating a power or energy model structure which may be utilized at various levels of a design flow.

The architecture 1004 references events names and values assigned in event_energy 1006. Event_energy 1006 references events defined in event_definition 1010. Events in event_definition 1010 are defined in terms of modes and transitions in mode_value 1012 and mutex_mode_definition 1008. Modes 1012 may be defined as combinatorial expressions of pin states 1014 in pin groups. It is noted that the overall model structure may vary in other embodiments. For example, in other embodiments, one or more levels not shown may be included within the structure 1000. Also, one or more levels shown may be omitted within the structure 1000 in overall embodiments.

In one embodiment, a gate level definition of a design may interface to structure 1000 through the pin level 1014. The pin transitions of the gate level definition may be described as transitions between modes, with modes being defined at level 1012. Then, the actual power calculations may be event-based and may be performed at the event_energy level 1006. For a RTL level definition of a design, the interface to the power model may be through pin level 1014, with power modeling calculations defined in terms of event energies at level 1006. These event energies in turn may reference the pin based data at level 1014 by defining events in terms of mode transitions, with the modes being defined in terms of states of pins. Alternatively, the event energies may be defined in terms of hard-coded data.

Generally speaking, multiple layers of a design may be modeled using a given power model. The given power model may be used in a gate-level simulation where the interface is all in terms of pins. The same given power model may also be used for a transaction-level simulation. The interface may be specified through a transaction definition, which references events within the given power model, which in turn references pins within the given power model. The given power model may be used for both transaction-level and gate-level simulations, but data may flow out of the model in two different ways. In one embodiment, the model may be implemented such that it has multiple ports. A first port may be a pin-based port, a second port may be a transaction-based port, and so on.

In one embodiment, the model may be constructed for a design in a bottom-up approach. The designer may start by doing modeling of low-level units. Then, as the design progresses and the designer works on larger units, the designer may reuse the already completed low-level modeling work. In another embodiment, the model may be constructed using a top-down approach. Initially, a simple model may be created based on transactions. In one embodiment, the model may be developed based on equations that work at the transaction level without reference to any underlying event-based or pin-based models. Then the model may be expanded to work at an intermediate level and then at lower levels, with the lower levels designed to accommodate and combine with the interfaces constructed at the transaction level. In a further embodiment, work at the low-level and work at the high-level of the model may be performed in parallel, and the model may be finished by combining at a middle level.

In some embodiments, a designer working at a high-level may use conditional expressions to define the energy for a given event. The conditional expression may use a high or mid-level value for a given energy event unless low-level data is available. For example, in one embodiment, an equation for a high-level modeling event may use pin-based data if that exists. If not, then other data may be specified at a higher level.

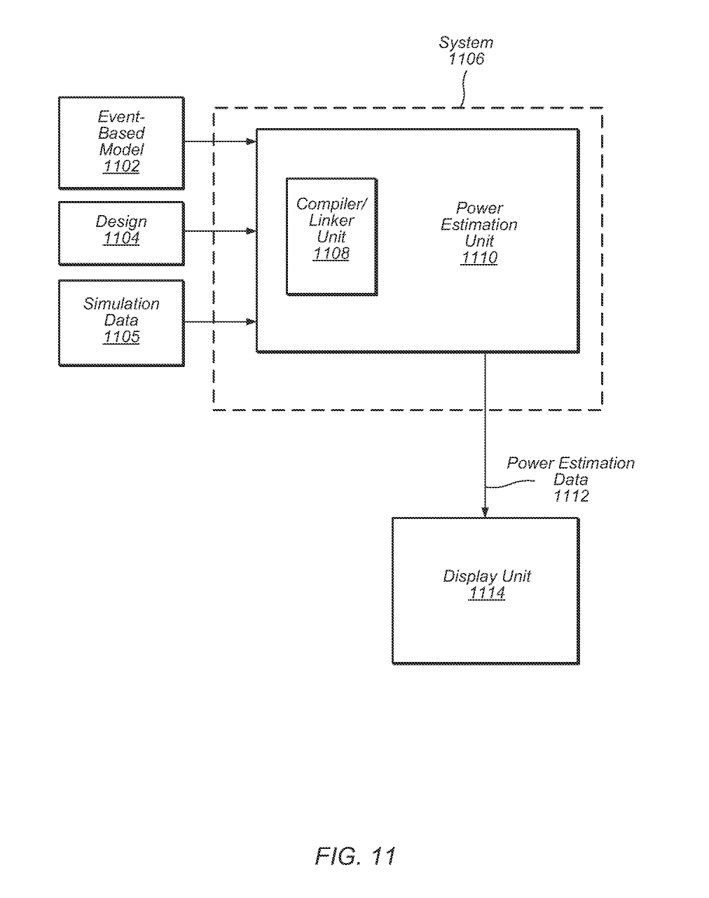

Referring next to FIG. 11, a block diagram of one embodiment of a system 1106 is shown. System 1106 may include one or more processors (not shown) and one or more memory devices (not shown). System 1106 may be any type of computing system (e.g., desktop computer, server) or computing device configured to execute various software programs and store various types of data. System 1106 may be configured to generate power estimation data 1112 which may be displayed on display unit 1114. Display unit 1114 is representative of any number and type of displays (e.g., monitor, LED, LCD, touchscreen). It is noted that power estimation data 1112 may also be referred to as power consumption or power dissipation data. In other embodiments, system 1106 may be configured to generate energy estimation data, timing estimation data, and/or other performance data.

Event-based models 1102 may be any type of models previously described. In one embodiment, event-based models 1102 may include a library of models of a plurality of elements specific to a particular target device technology. Event-based models 1102 may be referenced by design 1104, which is representative of any of various abstraction levels of a design. For example, in various embodiments, design 1104 may be a transaction-level design, RTL design, gate-level design, transistor-level design, netlist, or other hierarchical level of a design, or a combination of above.

Compiler/linker unit 1108 may compile and link the design 1104 with the event-based models 1102. This compilation and linking process may follow one or more of the steps previously described. Simulation data 1105 may also be provided to unit 1108 and may be used in the compilation and linking process. Alternatively, simulation data 1105 may be provided to power estimation unit 1110. Simulation data 1105 may include any type of stimulus data, such as a testbench or probabilistic stimuli, and may represent data that is expected to simulate actual conditions that a design may undergo in the target environment.

In one embodiment, the output of compiler/linker unit 1108 may be an executable program that may be provided to power estimation unit 1110. In another embodiment, the output of compiler/linker unit 1108 may be a linked object file that may undergo further processing by unit 1110. Unit 1110 may generate power estimation data 1112 from the output of unit 1108. It is noted that units 1108 and 1110 may be software, hardware, or any combination thereof. In other embodiments, units 1108 and 1110 may may be split up into two or more units in other embodiments. It is noted that system 1106 is only one possible embodiment of a system for modeling the power consumption of a design using event-based models. Other systems may include other devices, components, units, and software applications and may include one or more other steps in the power modeling process.

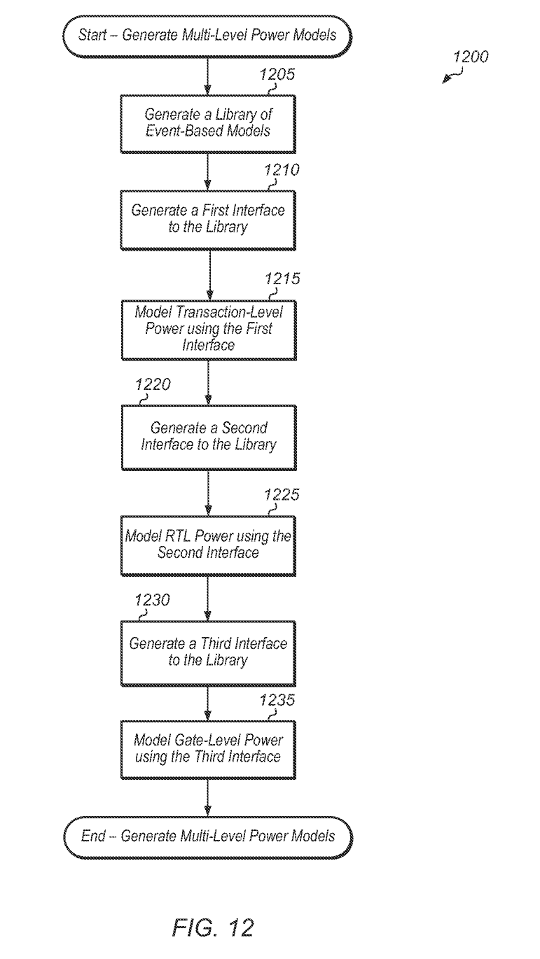

Turning now to FIG. 12, one embodiment of a method for utilizing event-based models in power modeling at multiple levels of abstraction is shown. For purposes of discussion, the steps in this embodiment are shown in sequential order. It should be noted that in various embodiments of the method described below, one or more of the elements described may be performed concurrently, in a different order than shown, or may be omitted entirely. Other additional elements may also be performed as desired.

In one embodiment, a library of event-based models may be generated (block 1205). The event-based models may include a base level of power data. Then, a first interface to the event-based models may be generated, and the first interface may be utilized to reference the event-based models from a transaction level of a design (block 1210). In one embodiment, the design may be an integrated circuit design. The first interface may be used for modeling the power consumption of the design at the transaction level (block 1215).

Then, a second interface to the event-based models may be generated, and the second interface may be utilized to reference the event-based models from a register transfer level of a design (block 1220). A register transfer level model of the power consumption of the design may be generated, and the model may utilize the second interface for referencing the event-based models (block 1225). A testbench or other stimulus, including timing data and various input signals, may be used to stimulate the design for use in estimating the power consumption of the design.

Then, a third interface to the event-based models may be generated, and the third interface may be utilized to reference the event-based models from a gate level of a design (block 1230). The third interface may be used to generate a gate-level power model of the design (block 1235). It is noted that the same event-based models may be utilized to estimate the power consumption of the design at multiple levels of abstraction. It is also noted that portions of method 1200 may be performed separately. For example, power may be modeled at a transaction level without modeling power at lower levels. It is also noted that in another embodiment, the design flow may begin with the gate level definition of the design in a bottom-up approach. In this embodiment, the first interface may be generated and used by the gate level definition of the design, and the third interface may be used by the transaction level definition of the design.

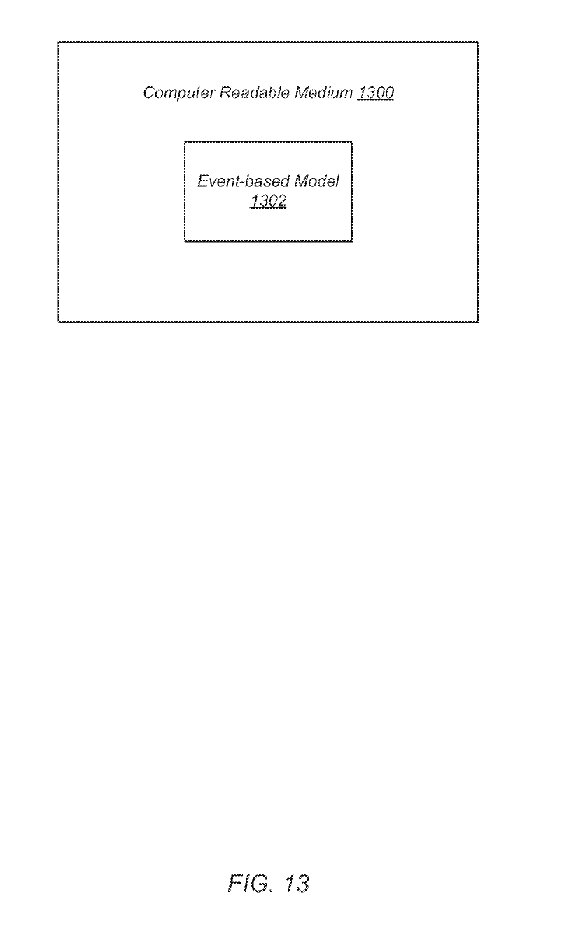

Turning now to FIG. 13, one embodiment of a block diagram of a computer readable medium 1300 including one or more data structures representative of event-based models 1302 is shown. Generally speaking, computer readable medium 1300 may include any non-transitory storage media such as magnetic or optical media, e.g., disk, CD-ROM, or DVD-ROM, volatile or non-volatile memory media such as RAM (e.g. SDRAM, RDRAM, SRAM, etc.), ROM, etc., as well as media accessible via transmission media or signals such as electrical, electromagnetic, or digital signals, conveyed via a communication medium such as a network and/or a wireless link.

Generally, the data structure(s) of the circuitry on the computer readable medium 1300 may be read by a program and used, directly or indirectly, to generate the hardware comprising the circuitry. For example, the data structure(s) may include one or more behavioral-level descriptions or register-transfer level (RTL) descriptions of the hardware functionality in a high level design language (HDL) such as Verilog or VHDL. The description(s) may be read by a synthesis tool which may synthesize the description to produce one or more netlists comprising lists of gates from a synthesis library. The netlist(s) comprise a set of gates which also represent the functionality of the hardware comprising the circuitry. The netlist(s) may then be placed and routed to produce one or more data sets describing geometric shapes to be applied to masks. The masks may then be used in various semiconductor fabrication steps to produce a semiconductor circuit or circuits corresponding to the circuitry. Alternatively, the data structure(s) on computer readable medium 1300 may be the netlist(s) (with or without the synthesis library) or the data set(s), as desired. In yet another alternative, the data structures may comprise the output of a schematic program, or netlist(s) or data set(s) derived therefrom.

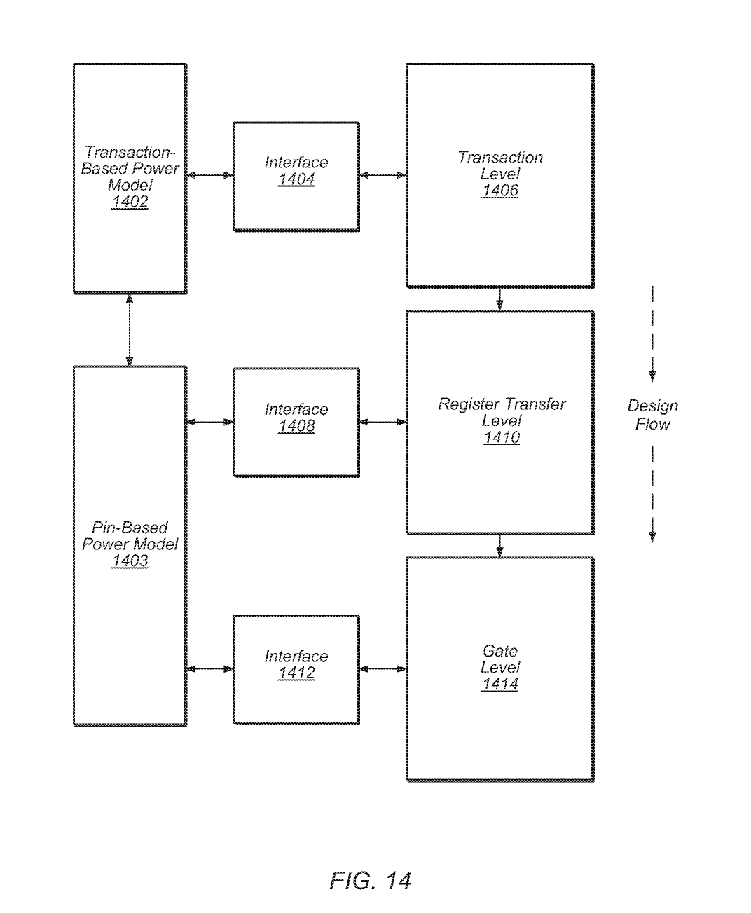

Turning now to FIG. 14, a block diagram of another embodiment of a multi-abstraction level power modeling scheme is shown. This scheme involves a top-down approach to generating a consistent power model. The transaction level definition of the design 1406 may use interface 1404 to access transaction-based power model 1402. Transaction-based power model 1402 may originate as a standalone power model for transaction level designs, but model 1402 may be expanded to interface to pin-based power model 1403 to leverage the data included within model 1403. Although not shown in FIG. 14, an interface may be used for accessing model 1403 from model 1402. This

interface may include an access method for referencing the data of model 1403. In some cases, this interface may be included within model 1402. In some embodiments, an application programming interface (API) may be used to interface from model 1402 to model 1403.

While a top-down approach to multi-level power modeling is presented in FIG. 14, a bottom-up approach may be used in some embodiments. In this bottom-up approach, the pin-based power model 1403 may be enhanced so that it is usable at all three levels (1406, 1410, and 1414) of the design flow. Additional constructs and semantics may be added to the pin-based power model 1403 to enable the use of model 1403 at multiple levels. For example, symbolic names may be established to extend the pin-based power model 1403, and these symbolic names may be used directly by the three levels. More specifically, event transitions may be defined in terms of pin transitions or in terms of other signal state transitions. Then, the power consumption may be defined in terms of event transitions or event energies.

The schemes described herein decouple the access method from the calculation method for power modeling. The schemes also decouple the access method from the data representation method. In one embodiment, the access method may involve using symbolic names. Symbolic names may be defined for modes and events, and power consumption may be defined in terms of these symbolic names. Modes may be defined in terms of states of pins, and pin transitions may be described as a transition between modes. In effect, the modes may be layered on top of the pin transitions. The modes and events described in the various schemes herein may be used at any level within a design flow by invoking the symbolic names.

Various techniques of building up power models for large functional blocks that can be used to accurately estimate power consumption when used with any of a plurality of various abstraction levels are disclosed herein. These techniques include mechanisms for modeling logic block power consumption at a transaction level model (TLM) abstraction. These mechanisms may be configured to reference existing lower-level, or cell-level, data. These mechanisms may be integrated with existing cell modeling standards, and the integrated models may provide multi-level support. In other words, a single model may be used with netlist, TLM, or RTL based design efforts for the purposes of power analysis and optimization.

In one embodiment, a mechanism for multi-level modeling may include the following elements: (1) base level power data with symbolic names for power consuming events, such as pin or mode transitions, (2) layered model structures requiring minimal recharacterization effort, (3) power equations that are functions of base power data named variables, and (4) multiple interface definitions.

The base level power data may include symbolic names for each individual power event that is modeled. For the higher level abstractions, power may be represented indirectly by power equations that contain references to each named power event. This indirection may be used to create a layered model structure that separates complex power conditions from measured data. Thus, when a power model is generated for a different manufacturing process, the entire model does not need to be recreated. Instead, only the base level power data may be regenerated and integrated with the higher levels.

The model may provide a plurality of interface options. For example, the model may be accessed at the pin level, which is the conventional level in primitive logic elements. The model may also be accessed at a more abstract level, such as at a transaction level. The data returned by an access at a particular level may be appropriate to that level, but all data returned may be built from the same underlying base of data in the model. In other words, the model may add a level of indirection to pin or mode transition data.

Generally speaking, the techniques disclosed herein provide the ability to define power equations in terms of the pin or mode transition power data. A single model may be used to simulate, calculate, and/or estimate power from multiple, different abstraction level descriptions. The techniques also include a layered model that utilizes indirection through named events to minimize power recharacterization effort.

The techniques disclosed herein can be implemented in a variety of ways including, as a system, apparatus, method, and a computer readable medium. It is noted that the illustrated systems may comprise various forms and types of software. In one embodiment, program instructions and/or a database that represent the described systems, components, and/or methods may be stored on a computer readable storage medium. Generally speaking, a computer readable storage medium may include any non-transitory storage media accessible by a computer during use to provide instructions and/or data to the computer. For example, a computer readable storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM)), ROM, non-volatile memory (e.g. Flash memory) accessible via a peripheral interface such as the USB interface, etc. Storage media may include micro-electro-mechanical systems (MEMS), as well as storage media accessible via a communication medium such as a network and/or a wireless link.

It should be emphasized that the above-described embodiments are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A method comprising:
creating a power model of a first energy event;
generating a first interface to access the power model from a transaction level definition of a design;
generating a second interface to access the power model from a register transfer level definition of the design; and
generating a third interface to access the power model from a gate abstraction level definition of the design.

2. An apparatus comprising one or more processors and one or more memory units, wherein the one or more processors are configured to:
generate a first interface to a set of event-based energies at a first level, wherein the first interface comprises indirect references to the set of event-based energies;
generate a transaction-level model of a first entity, wherein the transaction-level model references the event-based energies using the first interface; and
estimate a power consumption of the first entity using the transaction-level model.

3. A system comprising:
a compiler, wherein the compiler is configured to compile and link a plurality of event-based models to multiple levels of definition of a design, wherein the multiple levels include a transaction level definition of the design; and
a power estimation unit, wherein the power estimation unit is configured to generate a power model using the transaction level definition of the design from an output of the compiler.

4. The system as recited in claim 3, wherein the compiler is further configured to compile and link a plurality of event-based models to a register transfer level definition of a design, and wherein the power estimation unit is further configured to generate a power model using the register transfer level definition of the design from an output of the compiler.

5. The system as recited in claim 4, wherein the compiler is further configured to compile and link a plurality of event-based models to a gate level definition of a design, and wherein the power estimation unit is further configured to generate a power model using the gate level definition of the design from an output of the compiler.

6. A computer readable storage medium comprising program instructions, wherein when executed the program instructions are operable to:
generate a library of event-based models;
generate a first definition of a first design at a transaction level, wherein the first definition references the library of event-based models; and
generate a second definition of the first design at a gate level, wherein the second definition references the library of event-based models.

7. A computer readable storage medium comprising program instructions, wherein when executed the program instructions are operable to:
create a transaction level model of a design;
link a library of energy event models to the transaction level model using a first interface to the library of energy event models; and
generate a power model of the transaction abstraction level model using the linked library.

8. A method comprising:
generating a library of event-based models;
generating a first definition of a first design at a transaction level, wherein the first definition references the library of event-based models; and
generating a second definition of the first design at a gate level, wherein the second definition references the library of event-based models.

9. A method comprising:
generating a multi-level atomic power model, wherein power is defined in terms of event energies;
generating a first definition of a first design at a transaction level, wherein the first definition references the multi-level atomic power model; and
generating a second definition of the first design at a gate level, wherein the second definition references the multi-level atomic power model.

10. A method comprising:
creating a transaction abstraction level model of a design;
linking a library of energy event models to the transaction level model using a first interface to the library of energy event models; and
generating a power model of the transaction level model using the linked library.

11. The method as recited in claim 9, further comprising:
creating a register transfer level model of the design;
linking the library of energy event models to the register transfer level model using a second interface to the library of energy event models; and
generating a power model of the register transfer level using the linked library

12. A model of event-based energies, wherein the model is referenced by multiple abstraction levels of a single design.

13. The model as recited in claim 11, wherein a highest level of abstraction of a design definition uses a first interface to reference the model, wherein a middle level of the design definition uses a second interface to reference the model, and wherein a lowest level of the design definition uses a third interface to reference the model.

14. The model as recited in claim 12, wherein the highest level of abstraction is a transaction level definition of the design, wherein the highest level of abstraction is a register transfer level definition of the design, and the lowest level of abstraction is a gate level definition of the design.

15. A model of event-based energy, wherein the model includes multiple levels of interfaces, wherein multiple levels of a design definition utilize the multiple levels of interfaces to reference the model, and wherein the model references pin-based transition data.

16. The model as recited in claim 15, wherein the multiple levels of interfaces are cascaded together.

17. A first model of event-based energy, wherein the model includes multiple levels of interfaces, wherein multiple levels of a design definition utilize the multiple levels of interfaces to reference the model, and wherein the first model references a second model of pin-based transition data.

18. A system of providing multiple interface methods to interact with one or more event-based calculation methods for estimating power consumption at multiple levels of a design hierarchy, wherein power consumption is defined in terms of events.
